(19) United States
(12) Patent Application Publication
(10) Pub. No.: US 2026/0228219 A1
(43) Pub. Date: Aug. 6, 2026

(54) SYSTEMS AND METHODS FOR DYNAMICALLY PARSING JSON INTO BIGQUERY STRUCTURES

(71) Applicant: CenturyLink Intellectual Property LLC, Denver, CO (US)

(72) Inventors: Robert BUSHLACK, Littleton, CO (US); Robert WRIGHT, Broomfield, CO (US)

(73) Assignee: CenturyLink Intellectual Property LLC, Denver, CO (US)

(21) Appl. No.: 19/449,257

(22) Filed: Jan. 14, 2026

Related U.S. Application Data
(60) Provisional application No. 63/755,226, filed on Feb. 6, 2025.

(51) Int. Cl. G06F 16/2453; G06F 16/242

(52) U.S. Cl. CPC G06F 16/24542; G06F 16/242

(57) ABSTRACT

Disclosed are systems and methods for a computerized, dynamic JSON framework for working with complex JSON data in BigQuery environments. By implementing a multi-stage processing pipeline that preserves structural relationships while providing simplified access methods, the disclosed framework effectively bridges the gap between document-oriented and columnar data models. The framework’s ability to handle deeply nested structures, maintain structural integrity, and provide multiple access layers provides advanced and improved mechanisms for handling complex JSON data integration operations.

### CROSS-REFERENCE TO RELATED APPLICATIONS

This application claims the benefit of priority to U.S. Provisional Application No. 63/755,226, filed February 6, 2025, which is incorporated herein by reference in its entirety.

### FIELD OF THE DISCLOSURE

The present disclosure relates to a computerized framework for dynamically parsing JavaScript Object Notation (JSON) into BigQuery structures.

### SUMMARY OF THE DISCLOSURE

Modern data architectures frequently encounter the challenge of integrating JSON-formatted data (or JSON document(s), used interchangeably) databases (e.g., MongoDB, for example) with BigQuery for advanced analytics and data warehousing. Fundamental complexity arises from JSON-formatted data’s flexible, document-oriented structure that allows deeply nested JSON documents with varying schemas, compared to BigQuery’s more rigid, columnar storage model. Traditional integration approaches often require extensive ETL (Extract, Transform, Load) processes, schema mapping, and data transformation, which can be both resource-intensive and error-prone.

A particular pain point emerges when dealing with MongoDB exports, which typically produce massive JSON documents as single strings. These documents often contain complex nested structures, arrays, and objects that don’t naturally align with BigQuery’s standard JSON parsing capabilities. The current JSON-formatted data -to-BigQuery integration tools have notable limitations in handling deeply nested structures, null values, and varying schema definitions, while also requiring specific service dependencies that may not align with all architectural requirements.

To that end, according to some embodiments, as discussed herein, the disclosed systems and methods provide a computerized framework for a dynamic JSON schema, which addresses such challenges, among others, via innovative mechanisms that separate the structural analysis from the data querying process. Such separation allows for more flexible and robust handling of complex JSON data structures while maintaining query performance and data accessibility.

According to some embodiments, the disclosed framework can perform computerized schema analysis and structure mapping. In some embodiments, the disclosed framework can operate to perform automated schema analysis by examining either a JSON schema definition and/or sample JSON data directly. During this analysis phase, the framework can identify and catalog several key structural elements. For example, the framework can recognize primitive data types (strings, numbers, Booleans, and the like) and their locations within the document hierarchy. The framework can map complex nested objects and their relationship to parent structures, while also identifying array structures and their contained element types. Additionally, the framework can detect nullable fields and optional structures that may not be present in all documents.

In some embodiments, such structural analysis can be persisted within BigQuery’s metadata layer, creating a comprehensive map of the JSON document’s structure that can be referenced during query execution. The framework can maintain this structural metadata independently of the actual data, allowing for schema evolution and version control.

According to some embodiments, the framework can perform operations related to query generation and execution. That is, in some embodiments, once the structural analysis is complete, the framework can generate optimized Structured Query Language (SQL) queries that leverage BigQuery’s JSON functions. Such queries can be dynamically constructed based on the stored schema information, enabling several sophisticated capabilities. For example, the framework can build JSON traversal paths that accurately navigate nested structures, regardless of depth. The framework can generate appropriate NULL handling logic based on the identified optional fields and structures. Furthermore, the framework can optimize array operations by generating appropriate UNNEST and ARRAY operations based on the detected array structures.

In some embodiments, the query generation process performed by the framework can produce efficient SQL statements that maintain performance while handling complex JSON structures. Such queries can leverage BigQuery’s native JSON functions like JSON_EXTRACT, JSON_QUERY, and JSON_VALUE, with the added benefit of being dynamically generated based on the analyzed schema.

According to some embodiments, the framework can perform operations related to data ingestion and processing. That is, during the data ingestion phase, the framework can process JSON-formatted data exports in their native format, without requiring preliminary transformation. Such capability offers several advantages – for example, the framework can ingest raw JSON strings directly into BigQuery while maintaining the original document structure. The framework can handle documents that exceed typical JSON parsing limits by processing them in streaming chunks while maintaining structural integrity. Moreover, the framework can validate incoming documents against the stored schema information to ensure data consistency.

Accordingly, such direct ingestion capability significantly reduces ETL overhead and minimizes the risk of data loss or transformation errors during the import process. The framework can maintain the original document structure while making it queryable within BigQuery’s environment.

According to some embodiments, the framework can perform operations for query optimization and performance. In terms of query performance, the framework can implement several optimization strategies, such as, generating optimized JSON traversal paths that minimize repeated parsing of the same document sections; intelligent caching of frequently accessed document structures to reduce parsing overhead, partitioning large JSON documents based on access patterns to improve query performance, and the like. Such optimizations can significantly improve query performance compared to naive JSON parsing approaches, while still maintaining the flexibility to handle complex document structures.

According to some embodiments, the frame can further perform operations for schema evolution and maintenance. In some embodiments, to handle schema evolution and maintenance, the framework can provide several key capabilities, which can include, but are not limited to, detecting and adapting to schema changes in new documents without requiring manual intervention, maintaining multiple schema versions to support historical data analysis while accommodating new structures, generating schema migration paths to help maintain data consistency across schema versions, and the like. Such flexibility in schema handling is particularly valuable in environments where document structures evolve over time, as it minimizes the maintenance overhead typically associated with schema changes.

According to some embodiments, from an integration perspective, the disclosed framework can provide several interface options, which can include, but is not limited to, exposing standard SQL interfaces for querying the JSON data, making it accessible to existing BI tools and query engines; providing application program interfaces (APIs) for programmatic access to both the schema information and the data itself, supporting custom extensions for specific use cases or data structures, and the like. Such integration capabilities ensure that the framework can fit into existing data architectures while providing the flexibility to handle specialized requirements.

According, the implementation of the disclosed framework can provide several significant benefits. That is, the framework can reduce the time and effort required to integrate JSON-formatted data with BigQuery by eliminating manual schema mapping and transformation steps. The framework can improve query performance through optimized JSON parsing and intelligent caching strategies. Additionally, the framework can reduce maintenance overhead by automatically handling schema evolution and document structure changes. Such benefits can translate into reduced development time, improved data accessibility, and more reliable data integration processes.

Accordingly, the disclosed framework provides a technical solution to the challenge of integrating JSON-formatted data with BigQuery. By separating structural analysis from data querying and implementing intelligent optimization strategies, the framework provides a robust and flexible approach to handling complex JSON documents in a BigQuery environment. This not only solves the immediate challenge of processing large JSON-formatted data exports, but also provides a foundation for handling evolving document structures and maintaining high query performance. Indeed, the framework’s ability to dynamically generate optimized queries based on analyzed schema information, combined with its direct ingestion capabilities and schema evolution handling, makes it a powerful tool for organizations dealing with complex JSON data structures in their analytics environments. As data architectures continue to evolve and the volume of JSON-formatted data grows, such framework will become increasingly valuable for maintaining efficient and reliable data integration processes.

According to some embodiments, a method is disclosed for dynamically parsing JSON into BigQuery structures. In accordance with some embodiments, the present disclosure provides a non-transitory computer-readable storage medium for carrying out the above-mentioned technical steps of the framework’s functionality. The non-transitory computer-readable storage medium has tangibly stored thereon, or tangibly encoded thereon, computer readable instructions that when executed by a device cause at least one processor to perform a method for dynamically parsing JSON into BigQuery structures.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire‐line type connections, wireless type connections, cellular or any combination thereof. Likewise, sub‐networks, which may employ different architectures or may be compliant or compatible with different protocols, may interoperate within a larger network.

For purposes of this disclosure, a “wireless network” should be understood to couple client devices with a network. A wireless network may employ stand‐alone ad‐hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack‐mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web‐enabled client device or previously mentioned devices may include a high-resolution screen (HD or 4K for example), one or more physical or virtual keyboards, mass storage, one or more accelerometers, one or more gyroscopes, global positioning system (GPS) or other location‐identifying type capability, or a display with a high degree of functionality, such as a touch‐sensitive color 2D or 3D display, for example.

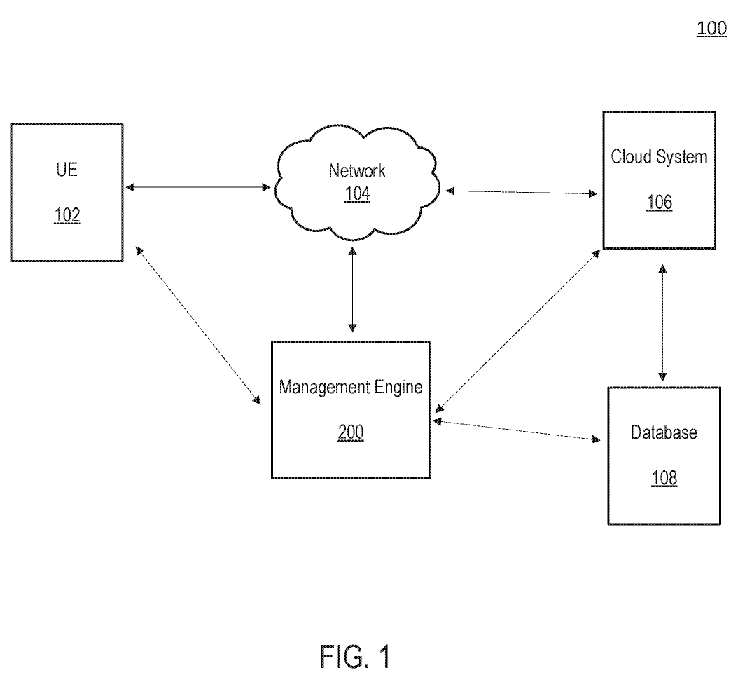

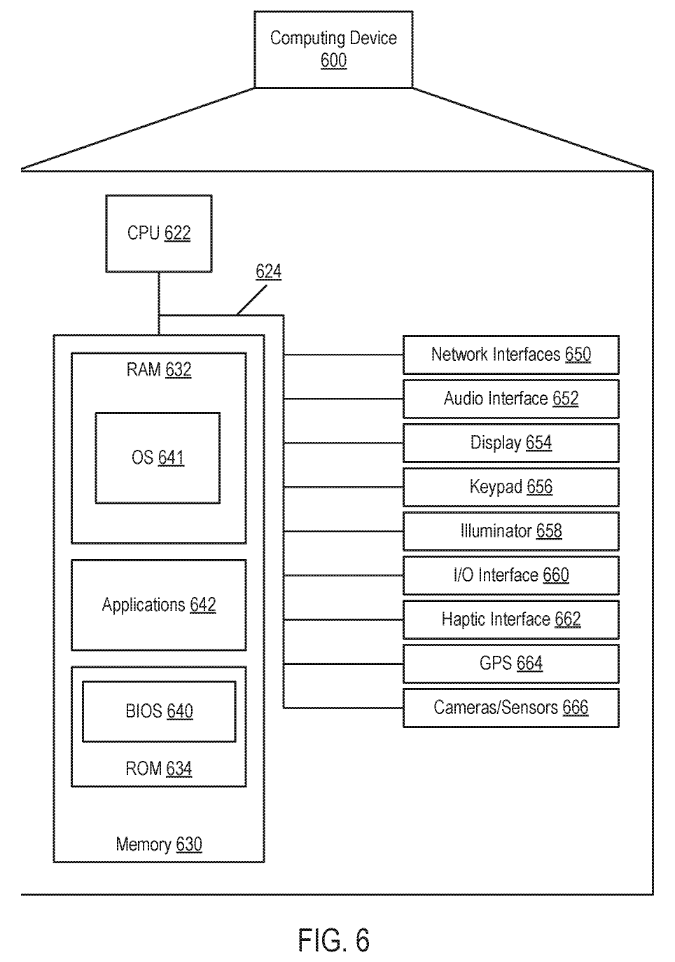

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and management engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network platform (e.g., Lumen® Technologies, for example), which has associated network resources hosted on the internet or private network (e.g., network 104), which enables (via engine 200) the functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

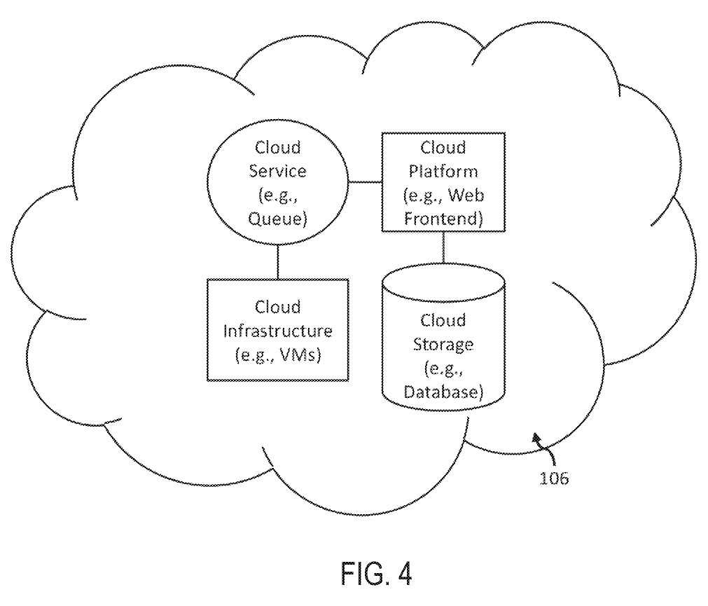

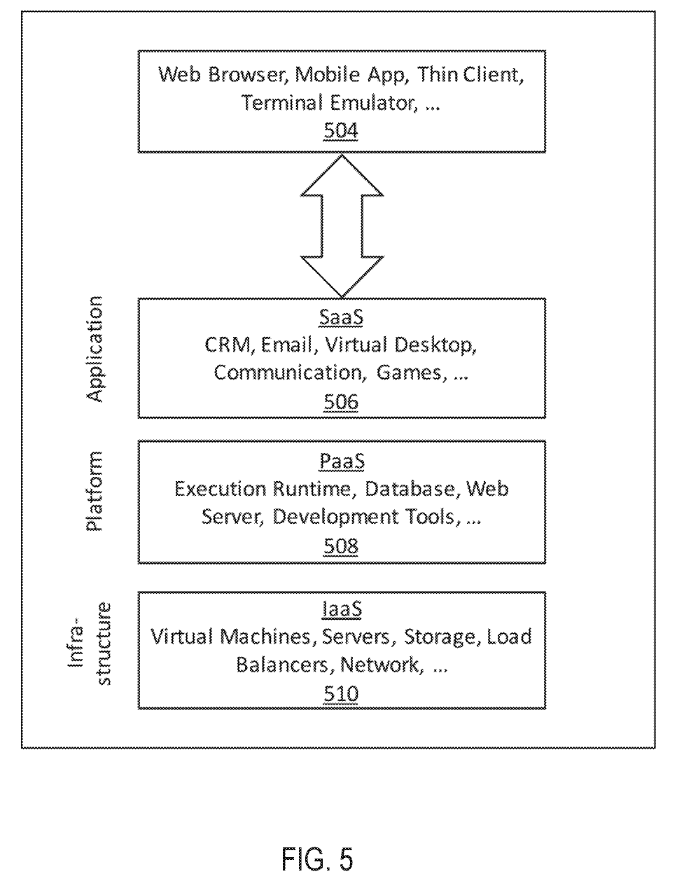

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: network as a service (NaaS) 510, platform as a service (PaaS) 508, and/or software as a service (SaaS) 506 using a web browser, mobile app, thin client, terminal emulator or other endpoint 504. In some embodiments, as understood by those of skill in the art, an infrastructure as a service (IaaS) can be implemented – for example, as part of and/or in addition to SaaS 506, PaaS 508 and/or NaaS 510. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 may be a special purpose machine or processor, and can be hosted by a device on network 104, within cloud system 106, and/or on UE 102. In some embodiments, engine 200 may be hosted by a server and/or set of servers associated with cloud system 106.

According to some embodiments, as discussed in more detail below, management engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below.

According to some embodiments, as discussed above, management engine 200 may function as an application provided by cloud system 106. In some embodiments, engine 200 may function as an application installed on a server(s), network location, database 108, and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102 and/or in connection with database 108.

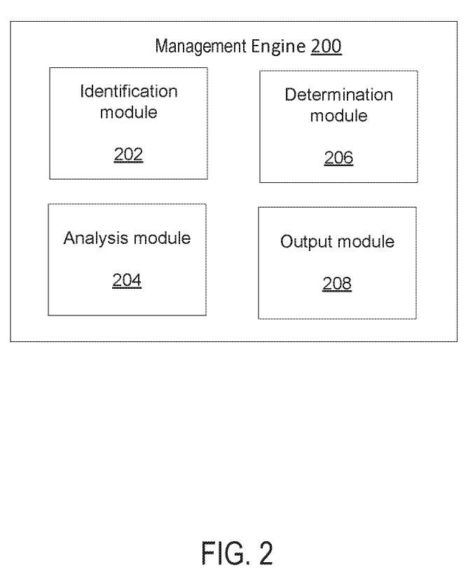

As illustrated in FIG. 2, according to some embodiments, management engine 200 includes identification module 202, analysis module 204, determination module 206 and output module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below. Management engine 200 or other device(s) running Process 300 may be operated entirely at the device level, or with cloud support as a distributed system, or at a service provider’s infrastructure, as non-limiting implementation examples. It will be understood that the disclosure herein provides for a configuration that is platform agnostic and may be operated on multiple alternative platforms as a matter of design choice using the teachings described.

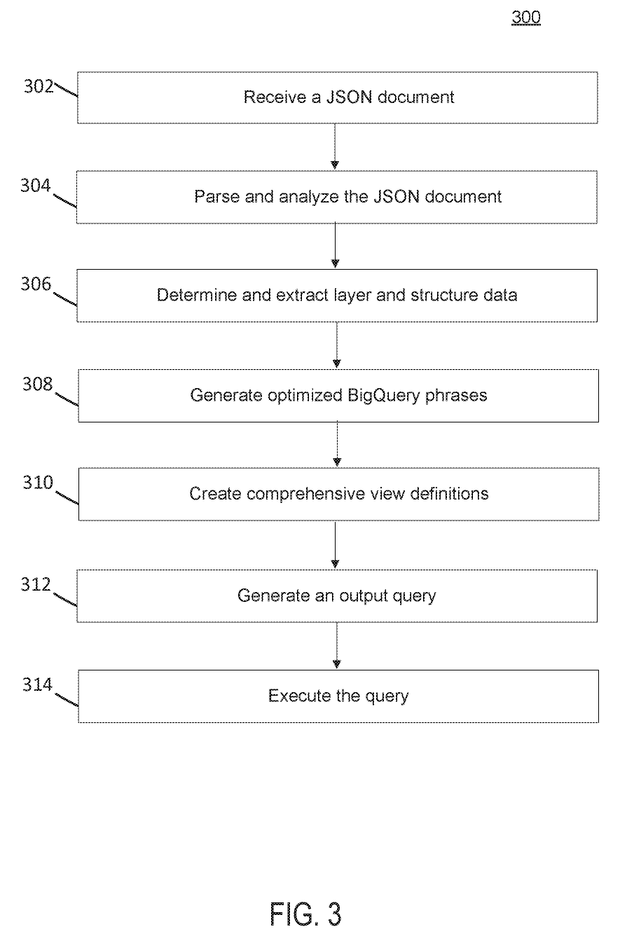

Turning to FIG. 3, depicted is Process 300 which details non-limiting example embodiments for the disclosed dynamic JSON schema. As discussed herein, the disclosed framework, embodied as engine 200, as discussed below with reference to the steps of Process 300, operates/functions as an innovative solution for dynamic JSON parsing and view generation that transforms complex JSON structures into queryable BigQuery views. In some embodiments, such mechanisms enable maintaining the original JSON structure while providing logical access paths to the data, effectively bridging the gap between document-oriented and columnar data models. Moreover, as evident from the discussion herein, the disclosed dynamic JSON parser can be applied to XML upon conversion to JSON.

In some embodiments, as discussed infra, the framework can operation to implement a multi-stage processing pipeline that begins with the data source (such as JSON-formatted data) and ends with queryable views in BigQuery. The framework can accept input from two primary sources: either a JSON schema (such as Swagger documentation) or the actual JSON data itself. When using schema-based parsing, the framework can capture all potential data attributes defined in the schema, whereas data-based parsing is limited to the attributes present in the analyzed records. In some embodiments, the framework can perform initial data ingestion through tools like Informatica’s mass ingest capability, storing the raw JSON strings in BigQuery tables as a data layer. This approach preserves the original data while enabling subsequent transformation and analysis.

In some embodiments, the framework can implement a recursive parsing algorithm that systematically analyzes the JSON structure. During this phase, the framework can, but is not limited to, identify and catalogue all elements, objects, and arrays present in the structure; determine data types for each element; capture sequence values and JSON paths for each element; record the nesting depth of each component; store all structural information in temporary tables for subsequent processing, and the like.

In some embodiments, such parsing process can maintain the hierarchical relationships between elements while preparing for the generation of appropriate BigQuery access methods. The framework can handle complex nested structures up to n (e.g., 15) levels deep, managing both array and object relationships throughout the hierarchy.

In some embodiments, after structural analysis, the framework can generate optimized BigQuery JSON extraction phrases. Such phrases can be constructed to, but not limited to: creating appropriate JSON_EXTRACT functions for accessing specific data elements; generating UNNEST commands for handling array structures; implementing correlated cross joins for flattening nested data; maintain proper sequencing of elements based on the original structure, and the like.

In some embodiments, the framework can combine these extraction phrases into comprehensive view definitions that preserve the original JSON structure while making it accessible through standard SQL queries. Such process can generate two types of views, which can include: a base view containing direct JSON extraction commands, and an “extract” view built on top of the base view that provides a more developer-friendly interface using BigQuery’s array and struct statements (e.g., a GoogleSQL view to select data from the JSON view using a familiar array, struck, UNNEST and dot notation from arrays, structs, for example).

According to some embodiments, the framework can maintain the original JSON structure while providing multiple access layers, which can include: a raw data layer containing the original JSON strings; an extraction view layer with direct JSON access functions; a flattened view layer for simplified querying; custom views built on top of the base views for specific use cases; and the like. As provided herein, such layering can allow for flexible data access while maintaining data integrity and structural consistency. The framework can handle complex structural elements including nested arrays, objects, and various data types while providing appropriate access methods for each.

In some embodiments, the framework can provide robust capabilities for handling schema changes and maintenance, which can include, but is not limited to: automatic detection of new or modified JSON elements; ability to rebuild views to accommodate structural changes; support for running without the actual JSON data present (schema-only mode); options for parsing with or without rebuilding phrases based on existing view status; and the like.

Accordingly, as provided herein, the implementation of such framework can provide several significant benefits, which can include, but are not limited to: simplified access to complex JSON data without requiring detailed structure knowledge; automatic view generation that matches JSON structure; an ability to build views before data availability using schema definitions; improved modification and maintenance of views as schemas evolve; support for development and data loading activities in parallel; and automatic capture of new or changed JSON elements, inter alia.

According to some embodiments, Step 302 of Process 300 can be performed by identification module 202 of management engine 200; Step 304 can be performed by analysis module 204; Step 306 can be performed by determination module 206; and Steps 308-314 can be performed by output module 206.

According to some embodiments, Process 300 begins with Step 302 where engine 200 can receive a JSON document. In some embodiments, engine 200 performs initial data ingestion by accepting input through two primary channels: either a JSON schema definition (such as Swagger documentation) or raw JSON data. In some embodiments, when processing schema-based input, engine 200 performs comprehensive attribute capture, allowing it to account for all potential data elements defined within the schema. Alternatively, in some embodiments, when processing raw JSON data, engine 200 performs analysis based on the actual attributes present in the examined records. The input can reach sizes up to half a terabyte and contain up to 1,200 distinct data elements within a single document, requiring robust handling capabilities.

In Step 304, engine 200 can function to parse and analyze the JSON document. According to some embodiments, during the parsing and analysis phase, engine 200 performs recursive traversal of the JSON structure, which can extend up to n (e.g. 15, for example levels deep. In some embodiments, engine 200 performs systematic identification of all JSON components, including primitive data types, nested objects, and array structures. During this analysis, engine 200 performs validation of JSON formatting and creates temporary storage structures to maintain the parsed information. In some embodiments, engine 200 can perform careful tracking of hierarchical relationships between elements, ensuring that the original document structure is preserved throughout the analysis process.

In Step 306, engine 200 can function to determine and extract layer and structure data. In so embodiments, engine 200 can perform detailed structural analysis during the layer and structure extraction phase. Engine 200 can perform cataloging of all identified elements, recording their data types, nesting levels, and relationships to parent structures. Engine 200 can perform sequence value assignment to maintain proper ordering of elements, while simultaneously generating JSON paths for each identified component. During this phase, engine 200 can perform special handling for array structures, preparing them for subsequent flattening operations through UNNEST commands. Engine 200 can store the extracted structural information in temporary tables, creating a comprehensive map of the JSON document’s architecture.

In Step 308, engine 200 can function to generate optimized BigQuery phrases. In some embodiments, engine 200 can perform creation of optimized BigQuery JSON extraction commands. Engine 200 can perform generation of appropriate JSON_EXTRACT functions for each identified data element, taking into account their position within the document hierarchy. Engine 200 can perform optimization of these phrases to ensure efficient query execution, including the generation of appropriate NULL handling logic for optional fields. In some embodiments, engine 200 can perform creation of UNNEST commands for array structures and develops correlated cross join statements for handling nested data relationships.

In Step 310, engine 200 can function to create comprehensive view definitions. In some embodiments, engine 200 can perform integration of the generated phrases into comprehensive view definitions during this phase. In some embodiments, engine 200 can create two distinct view layers: a base view containing direct JSON extraction commands, and a “extract” view that provides a more developer-friendly interface (as discussed supra). During view definition creation, engine 200 can perform preservation of the original JSON structure while making it accessible through standard SQL queries. In some embodiments, engine 200 can generate, create and/or compile struct and array statements that maintain proper relationships between elements while providing simplified access methods.

In Step 312, engine 200 can generate an output query. In some embodiments, engine 200 can compile all (or at least a threshold satisfying amount of) previous components into executable SQL statements. In some embodiments, engine 200 can create optimized query structures that maintain performance while handling complex JSON structures. Engine 200 can perform generation of appropriate joins and relationships between nested elements, ensuring proper data access paths are maintained. Engine 200’s operation can ensure the inclusion of the necessary BigQuery functions and commands to support both direct JSON access and simplified querying through the flat view layer.

And, in Step 314, engine 200 can execute the query generated in Step 312. According to some embodiments, engine 200 can perform validation of the generated query before execution. In some embodiments, engine 200 can perform optimization of the execution plan to ensure efficient processing of the JSON data. During execution, engine 200 can perform appropriate handling of array unnesting and object flattening operations via sequencing of operations to maintain data integrity and structural relationships throughout the query execution process.

According to some embodiments, throughout the steps of Process 300, engine 200 can perform supplementary operations that enhance its functionality and reliability. For example, engine 200 can perform schema evolution handling, such that engine 200 performs continuous monitoring for schema changes, allowing it to detect and adapt to modifications in the JSON structure. Engine 200 can perform automatic updates to view definitions when new elements are detected or existing elements are modified. This capability ensures that the views remain synchronized with evolving data structures.

In another example, in some embodiments, engine 200 can perform performance optimization techniques throughout its operation, which can include caching of frequently accessed structural information to reduce parsing overhead. Engine 200 performs intelligent partitioning of large JSON documents based on access patterns to improve query performance. Engine 200 can perform optimization of JSON traversal paths to minimize repeated parsing operations.

In yet another non-limiting example, engine 200, in some embodiments, can perform error handling and validation, which can involve comprehensive error checking and validation. For example, engine 200 can perform verification of JSON formatting to ensure data integrity. In another example, engine 200 can perform validation of generated SQL statements to ensure they meet BigQuery’s requirements. Indeed, engine 200 can function to monitor execution results to identify and handle any potential issues.

Moreover, in some embodiments, as discussed herein, engine 200 can perform external file processing, such that direct processing of external JSON files can be performed, thereby eliminating the need for preliminary loading into BigQuery tables. Engine 200 can perform streaming ingestion of JSON data while maintaining structural analysis capabilities.

Further, in some embodiments, engine 200 can perform enhanced validation, which can involve structure verification and data type checking. Such advanced error detection and correction can be performed during the parsing step, as discussed supra.

Furthermore, in some embodiments, engine 200 can perform automatic view generation based on detected JSON structures within a BigQuery environment. Engine 200 can perform scheduled monitoring and updates of views to maintain synchronization with changing data structures.

According to some embodiments, as evident from the disclosure herein, engine 200 can be configured and/or modified to perform similar operations on other database platforms beyond BigQuery. Engine 200 can perform generation of appropriate SQL syntax for different (e.g., known or to be known) database engines while maintaining the same structural analysis capabilities.

Accordingly, as provided herein, the disclosed systems and methods provide capabilities and functionality for improved handling of complex JSON data in analytical environments. By performing careful analysis, structured extraction, and optimized query generation, the disclosed framework (e.g., engine 200) provides a robust solution for organizations dealing with complex JSON integration challenges. The framework’s ability to perform maintenance of structural relationships while providing simplified access methods provides an essential tool for modern data architecture requirements.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving a JavaScript Object Notation (JSON) document, the document comprising information related to data within a database;
analyzing the JSON document, and determining layer and structure data;
generating, based on the determined layer and structure data, an optimized BigQuery phrase;
creating, based on the optimized BigQuery phrase, a set of view definitions, the view definition being at least one of a base view or flat view; and
generating, based on the set of view definitions, an output query for the database, the output query being a BigQuery structure.

2. The method of claim 1, further comprising:
ingesting the JSON document, wherein the ingesting is performed via at least one of schema definition or raw data.

3. The method of claim 1, further comprising:
performing structured analysis of the JSON document; and
identifying information related to at least one of a data type, nesting level or parent structure relationship, wherein the determined layer and structure data are based on the identified information.

4. The method of claim 1, further comprising the generating comprising a set of optimized BigQuery phrases.

5. The method of claim 1, further comprising the generating comprising performing at least one of an extract function or unnest function based on the determined layer and structure data.

6. The method of claim 1, further comprising: performing a flattening function based on a view definition from the set of view definitions.

7. The method of claim 1, further comprising:
executing the output query; and
performing validation operations based on the execution.

8. The method of claim 1, further comprising the output query comprising an array of Structured Query Language (SQL) queries that leverage BigQuery’s JSON functions.

9. The method of claim 1, further comprising performing automatic view generation based at least on the determined layer and structure data.

10. A non-transitory computer-readable storage medium tangibly encoded with computer-executable instructions that when executed by a processor, perform a method comprising:
receiving a JavaScript Object Notation (JSON) document, the document comprising information related to data within a database;
analyzing the JSON document, and determining layer and structure data;
generating, based on the determined layer and structure data, an optimized BigQuery phrase;
creating, based on the optimized BigQuery phrase, a set of view definitions, the view definition being at least one of a base view or flat view; and
generating, based on the set of view definitions, an output query for the database, the output query being a BigQuery structure.

11. The non-transitory computer-readable storage medium of claim 10, further comprising:
ingesting the JSON document, wherein the ingesting is performed via at least one of schema definition or raw data.

12. The non-transitory computer-readable storage medium of claim 10, further comprising:
performing structured analysis of the JSON document; and
identifying information related to at least one of a data type, nesting level or parent structure relationship, wherein the determined layer and structure data are based on the identified information.

13. The non-transitory computer-readable storage medium of claim 10, further comprising the generating comprising a set of optimized BigQuery phrases.

14. The non-transitory computer-readable storage medium of claim 10, further comprising the generating comprising performing at least one of an extract function or unnest function based on the determined layer and structure data.

15. The non-transitory computer-readable storage medium of claim 10, further comprising: performing a flattening function based on a view definition from the set of view definitions.

16. The non-transitory computer-readable storage medium of claim 10, further comprising:
executing the output query; and
performing validation operations based on the execution.

17. The non-transitory computer-readable storage medium of claim 10, further comprising the output query comprising an array of Structured Query Language (SQL) queries that leverage BigQuery’s JSON functions.

18. The non-transitory computer-readable storage medium of claim 10, further comprising performing automatic view generation based at least on the determined layer and structure data.

19. A system comprising:
a processor configured to:
receive a JavaScript Object Notation (JSON) document, the document comprising information related to data within a database;
analyze the JSON document, and determine layer and structure data;
generate, based on the determined layer and structure data, an optimized BigQuery phrase;
create, based on the optimized BigQuery phrase, a set of view definitions, the view definition being at least one of a base view or flat view; and
generate, based on the set of view definitions, an output query for the database, the output query being a BigQuery structure.

20. The system of claim 19, wherein the processor is further configured to:
perform structured analysis of the JSON document; and
identify information related to at least one of a data type, nesting level or parent structure relationship, wherein the determined layer and structure data are based on the identified information.
